(19) United States
(12) Patent Application Publication
(10) Pub. No.: US 2019/0168233 A1
(43) Pub. Date: Jun. 6, 2019

(54) VERTICAL GRINDING MILL, GRINDING MEDIA HANDLING SYSTEM, GRINDING MEDIA DISCHARGE DEVICE, AND METHOD FOR HANDLING GRINDING MEDIA

(71) Applicant: Metso Minerals Industries, Inc., Waukesha, WI (US)

(72) Inventors: Peter Henry Radziszewski, Baie D'Urfe, Quebec (CA); Lars Gronvall, Trelleborg (SE)

(73) Assignee: Metso Minerals Industries, Inc., Waukesha, WI (US)

(21) Appl. No.: 15/829,279

(22) Filed: Dec. 1, 2017

(51) Int. Cl. B02C 17/20; B02C 23/36; B02C 17/16; B02C 17/18

(52) U.S. Cl. CPC B02C 17/205; B02C 17/184; B02C 17/163; B02C 23/36

(57) ABSTRACT

A grinding media handling system for a vertical grinding mill comprises: a reservoir; a pump, such as a sump pump or a horizontal pump, for pumping water and/or a slurry of material to be ground from the reservoir via an inlet in an upper section of the vertical grinding mill into a grinding chamber of the mill; means for adding grinding media to the water and/or slurry upstream and/or downstream of the pump; and means for discharging slurry and grinding media from a lower section of the vertical mill.

### FIELD OF THE INVENTION

The present application relates to a grinding media handling system and a grinding media discharge system for a vertical grinding mill. The invention also relates to a vertical grinding mill and to a method for handling grinding media in a vertical grinding mill.

Vertical grinding mills are also called vertically stirred grinding mills or vertical auger mills.

A vertical grinding mill is available under the tradename “Vertimill” from Metso, for example.

### BACKGROUND

Vertical grinding mills use grinding media, also called grinding aids, for grinding the material to be ground such as minerals or ore. A common type of grinding aids are grinding balls made of steel. In the course of the grinding process, the grinding balls will wear down. Depending on the type of grinding mill, the type of material to be ground and the type of grinding balls, the amount of grinding media consumed per day can be in the order of 1.600 kg per day per mill, or even more. Fresh grinding media have to be added at certain points in time to compensate for the wear. This re-filling of a grinding mill with grinding media is conventionally being performed once a day, for example.

There are also situations in which the mill has to be entirely emptied of grinding media, for example to perform maintenance works such as the exchange of auger liners or if a different type of material is supposed to be ground which requires different grinding aids. After such a complete discharge, the mill has to be filled with a new charge of grinding media.

Conventionally, to refill or newly fill a vertical grinding mill with grinding media, mechanical systems such as cranes, hoists, skips, conveyors of many sorts, or the like have often been used to fill the grinding media charge into the upper part of the vertical grinding mill. Providing a crane or the like for this purpose is relatively expensive, though. In addition to that, such mechanical systems are often too tedious to cope with the large volume of media required to fill a vertical mill, especially as the mill sizes increase.

Discharging grinding media from a grinding mill is cumbersome, too. Conventionally, the grinding balls have been discharged manually from the mill. However, in order to get access to the grinding chamber in the grinding mill where the grinding media are accommodated, it is necessary to open a door in a bottom section of the mill, wherein measures have to be taken to provide for a controlled discharge and to prevent the grinding balls from simply falling out.

A further drawback of these conventional ways to fill and discharge grinding media is that the mill has a specific downtime when grinding media is discharged or recharged.

Hence, a problem encountered with vertically stirred grinding mills is high costs and high efforts to transport grinding media into and out of the vertical grinding mill.

WO 2012/069042 A2 discloses a handling system for grinding media in a horizontal ball mill in which the grinding media is filled into and discharged from the horizontal ball mill by means of a hydraulic medium circulated via a pump. The grinding media is filled into and discharged from the horizontal ball mill using one and the same port, which can e.g. be the port which is also used to fill in the material to be ground. To switch between filling and discharging, the flow direction of the pump is reversed.

### SUMMARY

An object of the present invention is to provide a system for handling grinding media in a vertical grinding mill which facilitates the filling of grinding media into and/or the discharging of grinding media from a vertical mill.

In order to achieve this object, the present invention provides, on the one hand, a handling system for grinding media for a vertical grinding mill according to claim 1.

By means of the grinding media handling system of the present invention, it is possible to fill grinding media into the vertical grinding mill without the use of cranes or the like mechanical devices. In addition to that, it becomes possible for the filling process to be performed partly or fully automatically, e.g. by monitoring the level of grinding media in the mill and adding grinding media until a predetermined level is reached.

Due to the possibility to refill grinding media during the grinding process, the grinding media height at the start of the grinding or upon start of the rotation of the screw shaft of the vertical mill can be reduced, so as to reduce the torque.

Advantages of the present invention are that a minimum infrastructure is needed as compared to prior art embodiments using cranes. In fact, standard pumps could be used as the transport means of the grinding media handling system of the present invention. Furthermore, grinding media can continuously be refilled, and the time for refilling the grinding media is reduced. Additionally, the costs are reduced.

On the other hand, the invention provides a device for discharging grinding media from a lower section of a vertical mill, wherein the vertical mill may include a grinding media handling system according to the invention, wherein the discharge means comprises a screw conveyor configured for conveying grinding media and slurry from a bottom section of the grinding chamber of the vertical mill.

The invention also provides a vertically stirred grinding mill as recited in claim 14 and a method for handling grinding media for a vertical grinding mill as set forth in claim 15.

The respective dependent claims define optional features.

### BRIEF DESCRIPTION OF THE DRAWINGS

The above, as well as additional objects, features and advantages of the present invention will be better understood through the following illustrative and non-limiting detailed description of preferred embodiments of the present invention with reference to the appended drawings, where the same reference numerals will be used for similar elements, wherein:

FIG. 1 shows a vertical grinding mill comprising a handling system according to a first embodiment of the present invention, comprising a sump pump for feeding grinding media into the vertical mill and a siphon;

FIG. 2 shows a vertical grinding mill comprising a handling system according to a second embodiment of the present invention, comprising a horizontal pump for feeding grinding media into the vertical mill and a siphon;

FIG. 3 shows a vertical grinding mill comprising a handling system according to a third embodiment of the present invention, comprising a horizontal pump for feeding grinding media into the vertical mill, but no siphon;

FIGS. 4a-4e show elements of a grinding media handling system according to modifications of the first to third embodiments of the present invention;

FIG. 5 illustrates a re-circulation of process water to the grinding media pump;

FIG. 6 illustrates the discharge of grinding media and slurry from a vertical mill, comprising a horizontal pump for feeding discharged grinding media and slurry to a stationary reservoir;

FIGS. 7a and 7b show a vertical grinding mill comprising a discharge device employing a conveyor screw;

FIGS. 8a and 8b show details of the screw and the conveyor screw of the discharge device of FIGS. 7a and 7b;

FIGS. 9a, 9b and 9c show details of the discharge device of FIGS. 7a and 7b;

FIG. 10 shows details of the discharge chute of the discharge device of FIGS. 7a and 7b;

FIG. 11 shows a screw conveyor of the discharge device of FIGS. 7a and 7b; and

FIG. 12 shows an alternative conveyor screw for the discharge device of FIGS. 7a and 7b.

### DETAILED DESCRIPTION

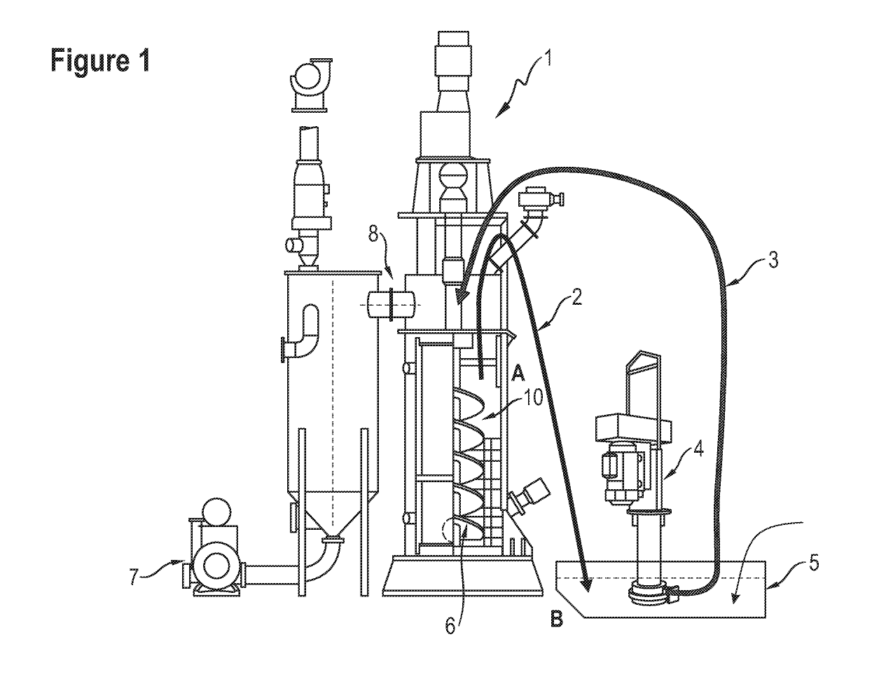

FIG. 1 depicts a vertical grinding mill for grinding minerals and/or ore. The vertical grinding mill 1 comprises a screw shaft 6 accommodated in a grinding chamber 10. To perform the grinding process, the grinding chamber 10 is filled with the material to be ground, water, grinding media such as grinding balls, and optionally additives, and stirred by means of the screw shaft 6. The mixture of the material to be ground and water is also referred to as slurry.

In the embodiment of FIG. 1, the vertical grinding mill 1 comprises a sump pump 4 as a transport means for delivering grinding media from a sump or reservoir 5 via a pipe 3 through an inlet at the top of the vertical mill and into the grinding chamber 10. The sump or reservoir 5 is located at the level of a lower section B of the vertical mill, e.g. at ground level, whereas the inlet is located at an upper section A of the vertical mill. As a consequence, the pump 4 must be configured to pump the grinding media to a significantly elevated level. The height difference between the reservoir 5 and the inlet for the grinding media can e.g. be as large as 12 meters or more.

The grinding media is usually provided in the form of grinding balls which are often made from steel, but could also be made from stone or ceramics material. In order to have the grinding media in a condition in which it can be pumped, the grinding media is fluidized by adding a sufficient amount of water or slurry to the grinding media and then pumped together with the water or slurry.

In this embodiment, a valve-controlled siphon 2 is provided to feed slurry from the grinding chamber 10 against gravity to an upper portion of the mill and back to the reservoir.

The vertical grinding mill 1 further comprises a recycle pump 7 and an overflow launder 8. The overflow launder 8 defines the level of the slurry during operation.

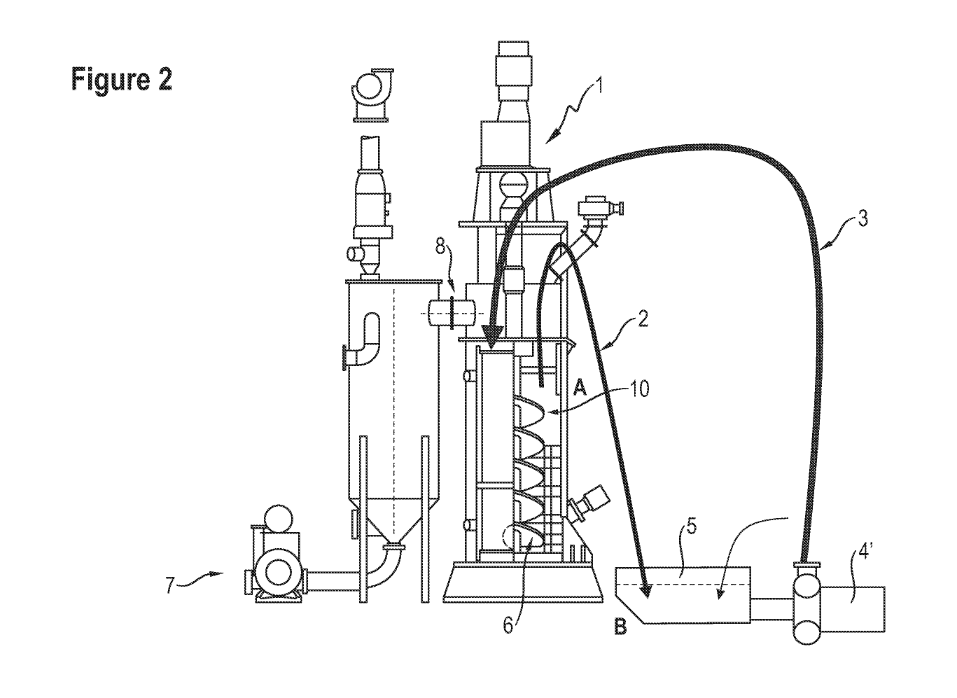

The embodiment of FIG. 2 shows an alternative, namely the use of a horizontal pump 4′ to feed the grinding media—again mixed with an appropriate amount of water or slurry—into the vertical mill.

With both embodiments, the sequence of operating steps to fill grinding media into the vertical grinding mill is essentially as follows:

a) fill the vertical mill with a slurry of material to be ground and start an auger of the vertical mill;

b) start a pump 4, 4′ configured for transporting grinding media from a reservoir 5 via an inlet in an upper portion A of the vertical grinding mill into a grinding chamber 10 of the mill,

c) start a siphon 2, e.g. by opening an anti-siphon valve, to feed slurry from the grinding chamber against gravity to the upper portion A of the mill and back to the reservoir 5 so as to fill the reservoir 5,

d) start adding grinding media to the reservoir 5, and

e) continue operating the pump 4, 4′ to transport the grinding media from the reservoir 5 into the grinding chamber 10.

In step e), the amount of grinding media in the grinding chamber may be monitored, e.g. by way of a suitable sensor. The method may further comprise step f1) of stopping adding fresh grinding media when the amount of grinding media in the grinding chamber has reached a predetermined level, and step f2) of stopping the siphon 2, preferably by allowing air into a top portion of the siphon 2.

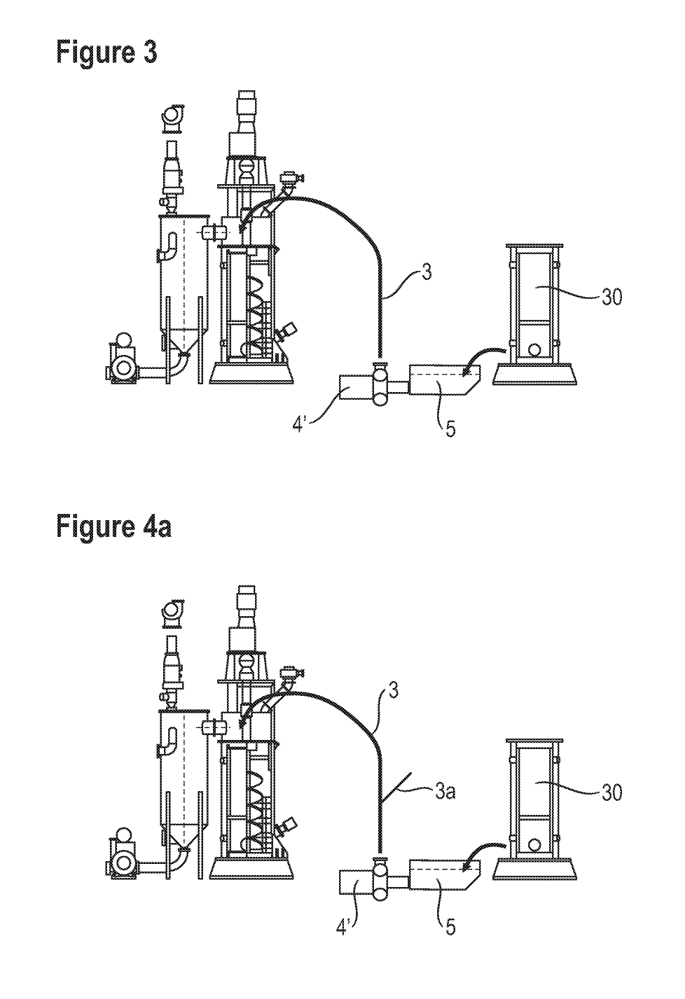

FIG. 3 illustrates a third embodiment of the present invention. The third embodiment basically corresponds to the second embodiment and includes a horizontal pump 4′, too, but it does not use a siphon. A stationary media reservoir 30 is part of the handling system of this embodiment. Grinding media and water or slurry are dumped from the stationary media reservoir 30 into the reservoir 5 and pumped from the reservoir 5 into the vertical mill by way of the horizontal pump 4′.

In the third embodiment, a sump pump such as the one of the first embodiment could be used instead of the horizontal pump 4′. Still different types of pumps could be used as well.

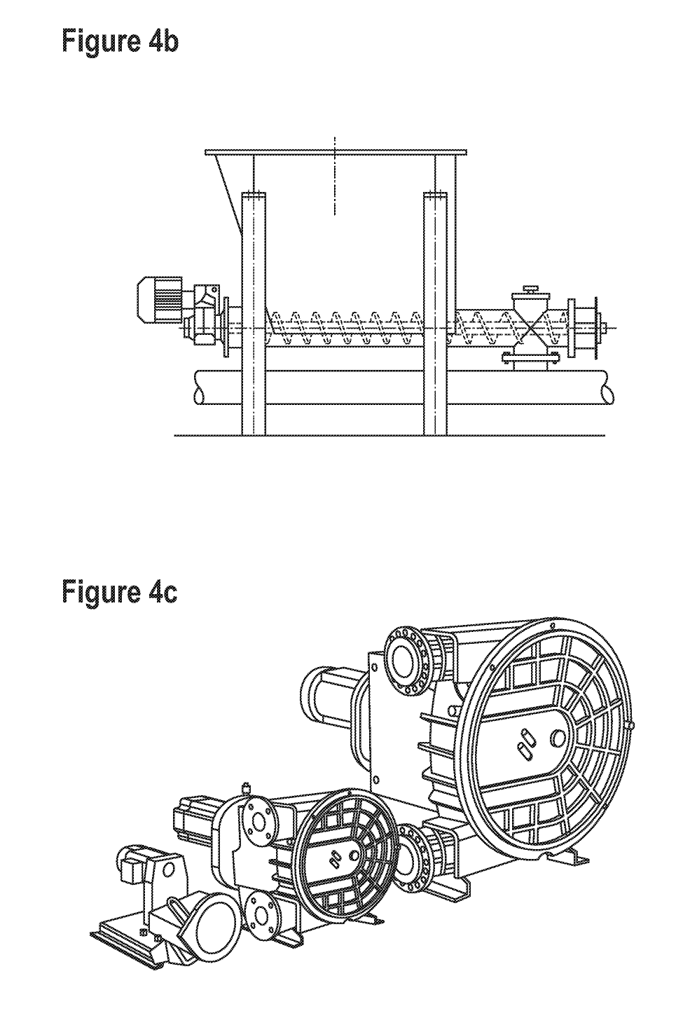

The concept illustrated in FIG. 3 is to use the pump, e.g. sump pump or horizontal pump 4′, to convey the grinding media together with the slurry or water into the vertical mill. A modification of this concept will now be described with reference to FIGS. 4a-4e.

Generally speaking, this modification resides in using feeding means to feed the grinding media into a stream of water or slurry downstream of the pump. A corresponding embodiment is schematically indicated in FIG. 4a: in this modification, the stationary reservoir 30 would contain water or slurry, and water or slurry would be dumped from the stationary reservoir 30 into the reservoir 5 in order to be pumped into the vertical mill. The grinding media, in contrast, would be added via a pipe connector 3a to the slurry or water being pumped through the pipe 3 and into the vertical mill.

The pipe connector 3a could be designed so as to create a venturi effect.

To the pipe connector 3a, the grinding media is fed using feeding means which include e.g. an auger feeder as illustrated in FIG. 4b.

It is to be noted that by way of the pump, e.g. sump pump 4 or horizontal pump 4′, the grinding media and slurry are pumped to a considerable height which can e.g. be as large as 12 meters. This will create a certain backpressure at the point where the grinding media is being fed into the slurry/water stream. In order to prevent any corresponding flowback through the auger feeder, the feeding means may further comprise a pressure feeder such as a peristaltic pump (FIG. 4c) or a rotary vane feeder (FIGS. 4d and 4e), which pressure feeder is arranged at the discharge of the auger feeder and fed by the auger feeder, and which pressure feeder is configured for feeding the grinding media into the stream of water or slurry in the pipe 3 via e.g. the pipe connector 3a. If a peristaltic pump is used, the container (not shown) containing the grinding media is required to be filled with water. Alternatively, when a vaned impeller is used, the container containing the grinding media could stay basically dry.

In the embodiments described above, one pump is associated with one vertical mill. It is, however, also considered to use one pump for feeding grinding media to two or more vertical mills. The vertical mills would then be connected to the pump via a piping system so that the flow of grinding media, and water/slurry required for pumping, is divided downstream of the pump and distributed to the two or more vertical mills. Valves could be incorporated into the piping system to open and close the feed of grinding media towards the respective vertical mills as desired. The excess process water re-circulated from the individual vertical mills could in turn be collected in one re-circulation line and guided back to the suction side of the pump.

A clean-out access can be provided in the piping system to address potential problems which could arise if and when there is a sudden power outage. In this situation, all grinding media will fall back down to the lowest point in the circuit. A clean-out access will allow quick access to the media that needs to be emptied out before the system can be started again.

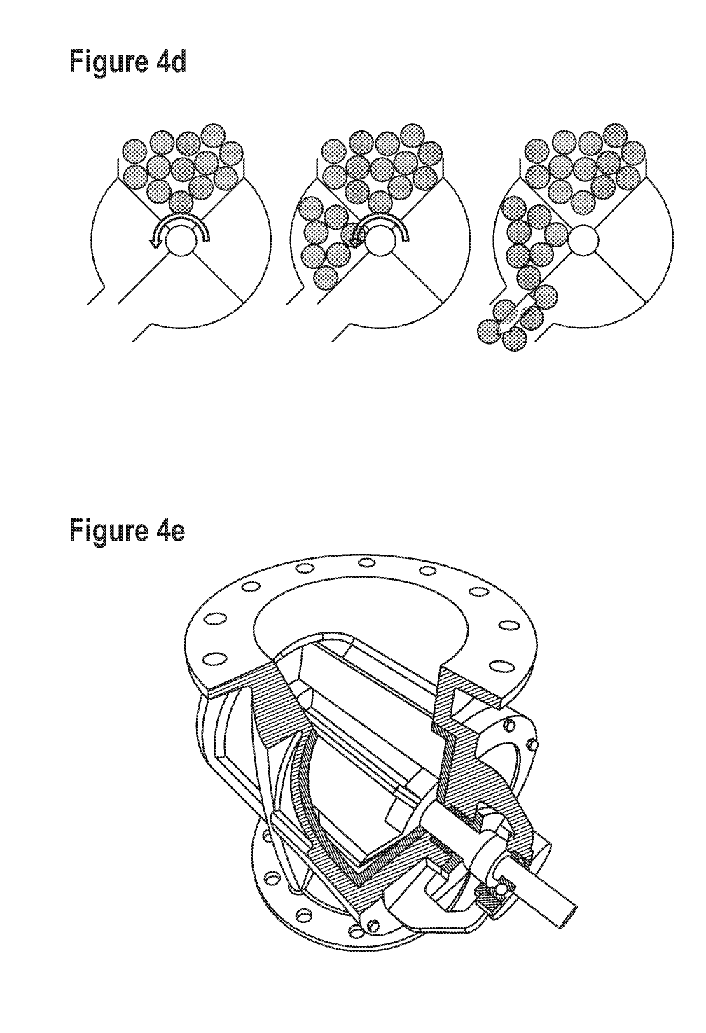

FIG. 5 illustrates how a vertical pump, which is used in any of the preceding embodiments to feed the water/slurry into the vertical mill, could be used in a pumping circuit. In certain situations, the vertical mill is completely emptied and re-filled, e.g. before and after a liner change-out, respectively. The mill could then be filled with enough process water that an overflow is created which can be re-circulated via the pump. In FIG. 5, GM indicates the grinding media input stream which is added to the vertical mill via an inlet port 40, and PW indicates the process water overflow stream, which is guided to the slurry/water pump (not shown here). WL designates the process water level for pumping purposes and CL the required charged level for start-up. Furthermore, the pumping height could be limited for the refill to just above the point where mill is considered full.

During operation, the mill can also be topped-up with fresh grinding media using process water to pump the grinding media into the mill. In order to maintain a desired slurry density, the grinding media can be screened out at the top of the mill and added to the mill, whereas the process water can be recirculated.

In an alternative, to top up the mill with fresh grinding media, the grinding media could be mixed with slurry and fed to the mill in order to add both fresh grinding media and further slurry to the mill. A slurry stream can for example be diverted from a given vertical mill, mixed with fresh grinding media, and used to top up another vertical mill. The slurry and grinding media could then be added to the mill via an inlet port similar to the one used to fill the mill with process water (inlet port 40 in FIG. 5). An optimal point for the inlet port 40 can be determined that works both for filling after liner change-out and for top-up purposes.

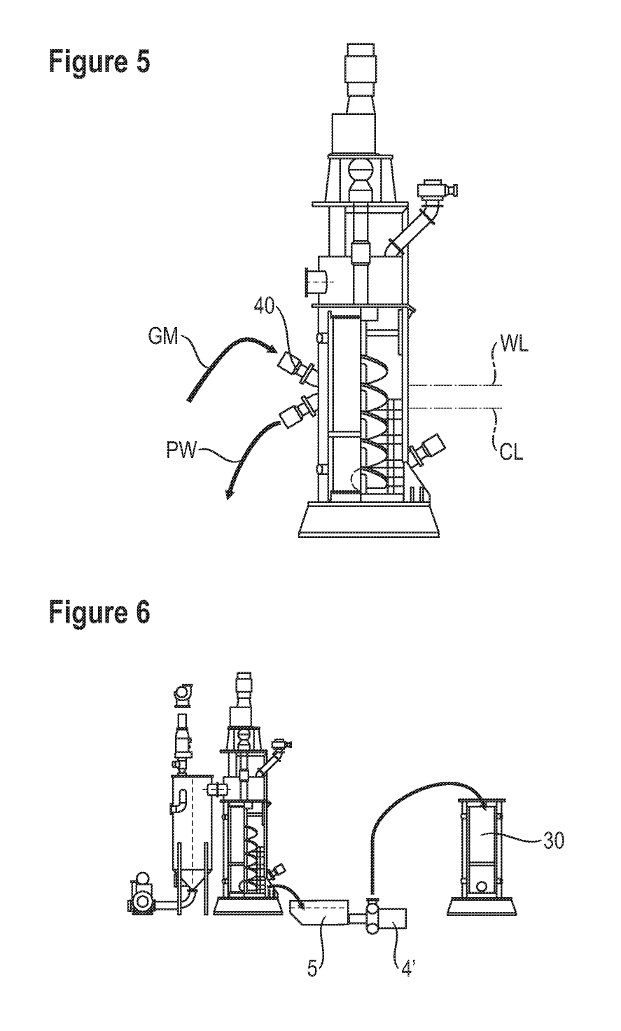

FIG. 6 illustrates how grinding media and slurry could be discharged from a vertical grinding mill according to any of the embodiments described above. For the discharge, a reservoir 5, a horizontal pump 4′ and a stationary media reservoir 30 are provided, similar as in the handling system of the third embodiment described above. The horizontal pump 4′ is, however, installed so as to pump grinding media and slurry, which have been discharged from the vertical mill to the reservoir 5, from the reservoir 5 into the stationary media reservoir 30. In other words, grinding media and slurry are dumped from a lower section of the vertical mill into the reservoir 5 and pumped from the reservoir 5 into the stationary media reservoir 30 by way of the horizontal pump 4′. In any vertical mill, including vertical mills comprising a grinding media handling system according to any one of the embodiments described above, the grinding media could be discharged this way.

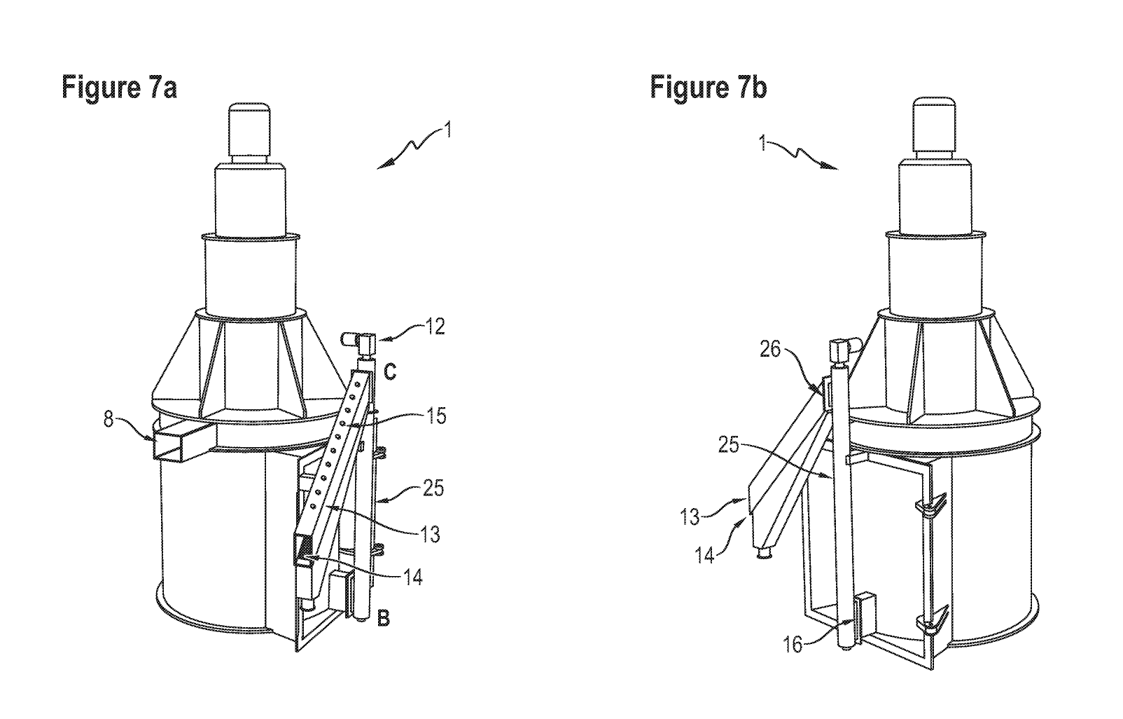

FIGS. 7a and 7b show a discharge device for a vertical grinding mill 1 which could also be used in any vertical mill, including vertical mills comprising a grinding media handling system according to any one of the embodiments described above. In this embodiment, the discharge device has a screw conveyor 25 for transporting the used grinding media from a discharge outlet at the lower section B of the mill to an elevated position C situated at a higher level than the discharge outlet. A drive train 12 for driving the screw conveyor 25 is provided. Further, the discharge means comprise a downwardly inclined discharge chute 13 over which the material taken out of the mill and lifted up via the screw conveyor is transported while being screened as explained further below.

A water supply 15, preferably a plurality of nozzles, is provided in the discharge means. Preferably, the nozzles are spaced along the discharge chute 13. The water supply allows for a cleaning of the used grinding media from slurry when passing through the discharge means 13.

The discharge chute 13 preferably comprises a screening means—illustrated is a screen plate 14—for separating the used grinding media from the slurry.

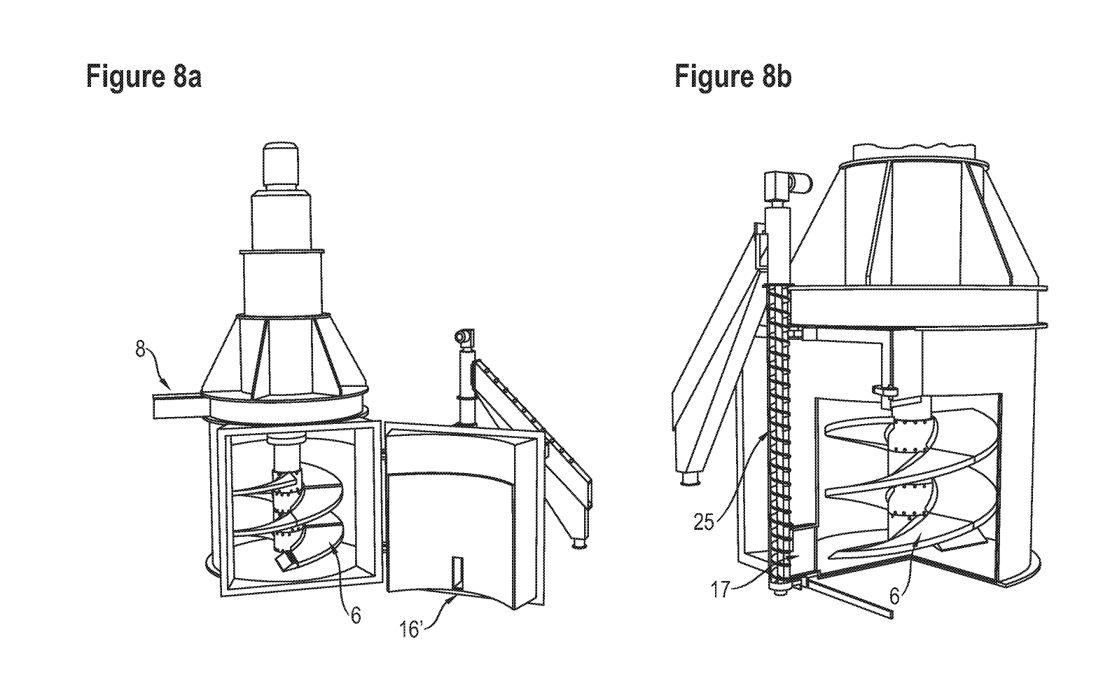

A connection point 16 for connecting the discharge device to the vertical grinding mill 1 is provided at the conveyor screw 25. A corresponding connection point 16′ is provided in the door of the vertical grinding mill 1, see FIG. 8a, so as to provide a connection with the corresponding connection point 16 of the conveyor screw 26. By means of the connection points 16 and 16′, used grinding media and slurry are fed from the bottom of the grinding chamber 10 to the entrance 20 of the conveyor screw 25.

By means of the overflow port 8, slurry including ground material overflows and exits the grinding chamber 10 for further treatment. The overflow port 8 (which is designated “overflow launder” further above) thereby defines the level of the slurry during operation.

FIGS. 8a and 8b depict the screw 6 within the grinding chamber 10 of the vertical grinding mill. The screw 6 is used to agitate the slurry and the grinding media by rotating the screw 6.

A sensor 17 for measuring the pressure and the charge level in the grinding chamber 10 in the vertical mill is provided, preferably in the bottom of the grinding chamber.

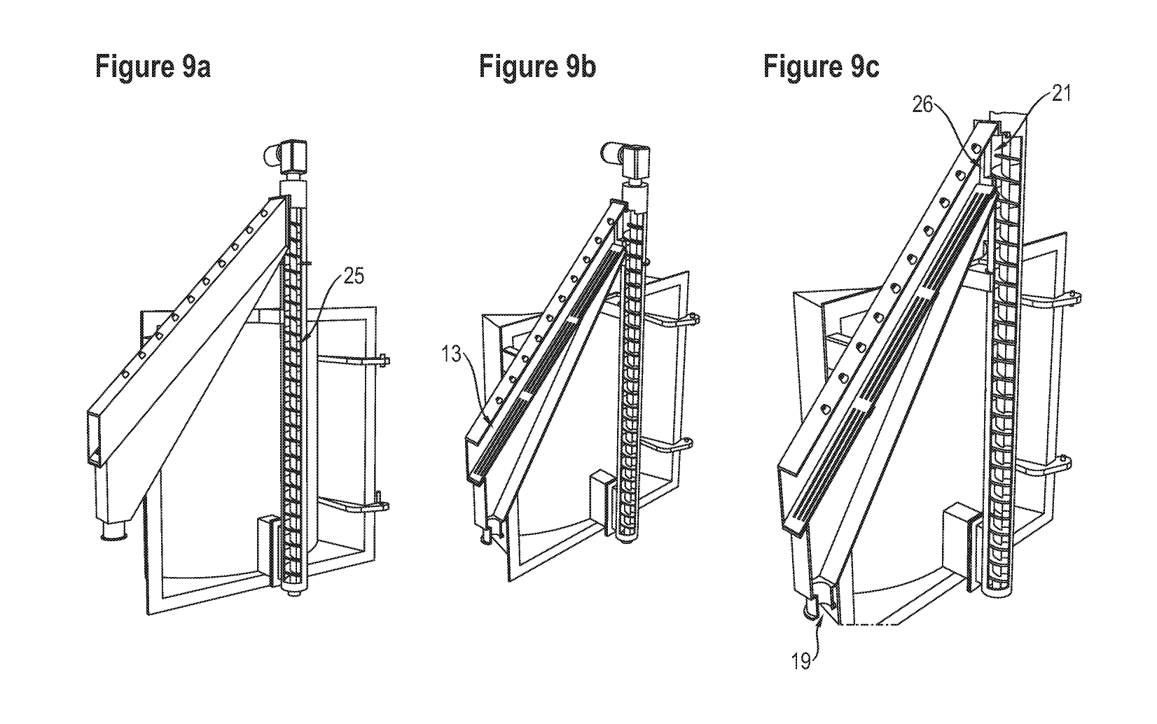

FIGS. 9a, 9b and 9c show details of the screw conveyor 25 and of the discharge chute 13. An exit portion 19 at the lower end of the discharge chute 13 is provided which receives the accept from the screening means 14, i.e. the slurry and wash water. From the exit portion 19, the slurry washed away from the grinding media can be pumped directly where ever preferred, e.g. back to the process such as back into the vertical grinding mill for further grinding, if desired. The grinding media, which constitutes the reject from the screen plate 14, is collected.

Preferably, the conveyor screw 25 is vertically arranged. Put differently, the conveyor screw 25 would have an axis of rotation which is parallel to the axis of rotation of the grinding screw 6.

The discharge chute extends in an angle of, for example, about 20 to 50° from the elevated position C to a lower position, preferably the lower section B of the vertical mill.

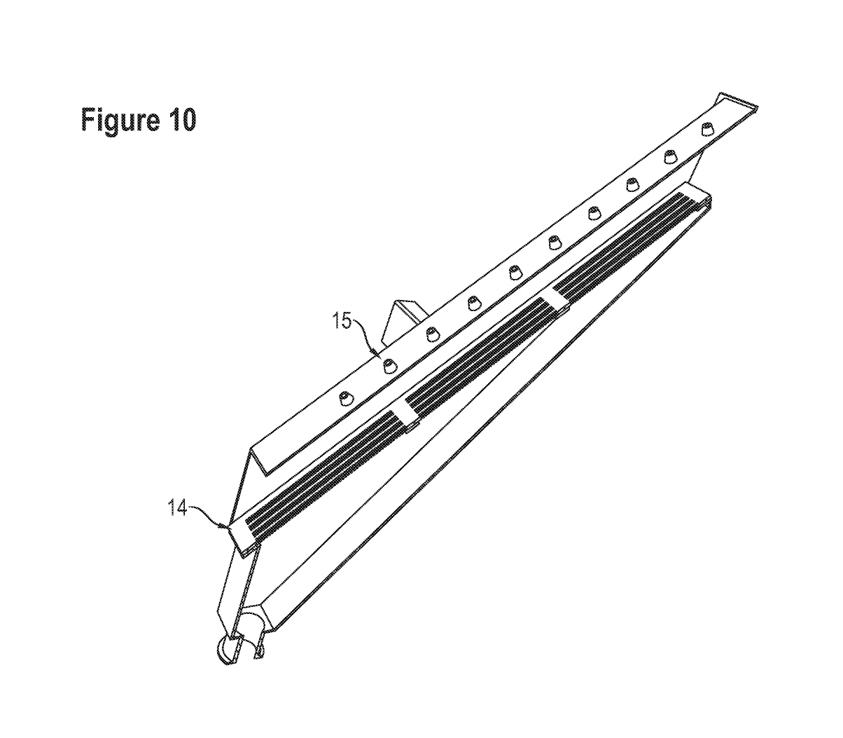

As depicted particularly in FIG. 10, the discharge chute 13 comprises the series of nozzles 15 for supplying water, and the screening means 14. The screening means 14 are configured for receiving the used grinding media. The aperture size of the screening means 14 depends on the size of the used grinding media. The screening means 14 allows for separation of the used grinding media from the slurry, and/or for separation of grinding media which can be re-used from grinding media which is worn down, i.e. from grinding media which is substantially smaller in diameter than fresh grinding media. Hence, the discharge chute 13 has an integrated washing means and screening means 14.

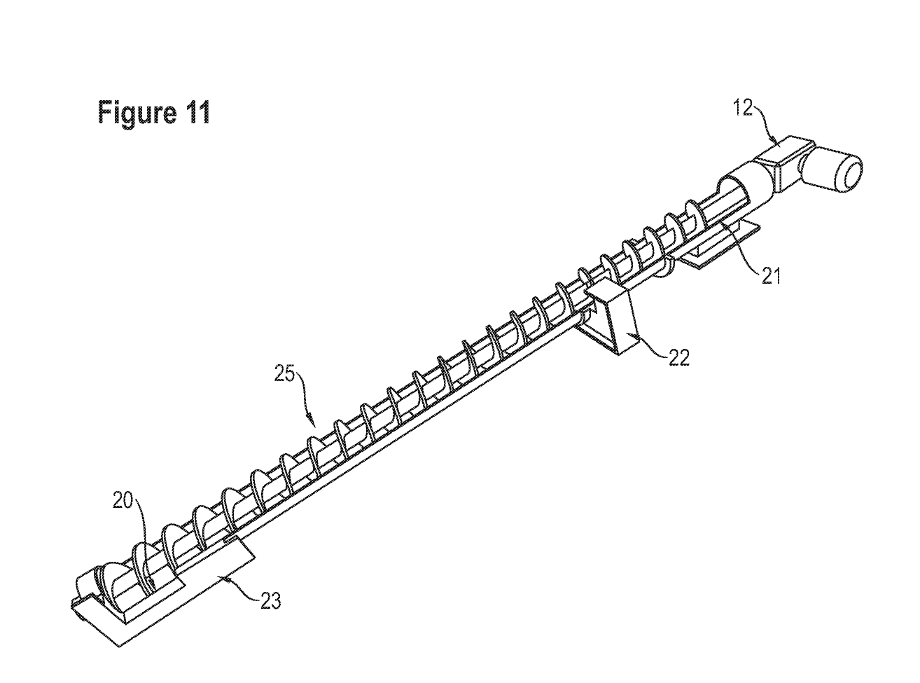

FIG. 11 shows the conveyor screw 25 in detail. The pitch of the conveyor 25, the flight width and the diameter of the screw depends on the grinding media size and also on the speed with which the slurry and the grinding media should be transported by means of the out from the bottom of the grinding chamber. A holder 22 for connecting to the vertical grinding mill is provided. Grinding media enters the conveyor screw 25 at the entering point 20 (at the lower position B) and is transported to the discharge point 21 at the other end of the conveyor screw 25, namely at the highest portion C. A flange 23 is used to fix the conveyor screw 25 to the vertical grinding mill.

At the discharge point 21 of the conveyor screw 25, the slurry and the used grinding media are supplied to the upper end 26 of the discharge chute 13. The upper end 26 of the discharge chute 13 and the discharge point 21 of the conveyor screw 25 are positioned above the overflow 8. The reason is that the discharge chute 13 should not act as a drain for the grinding chamber 10.

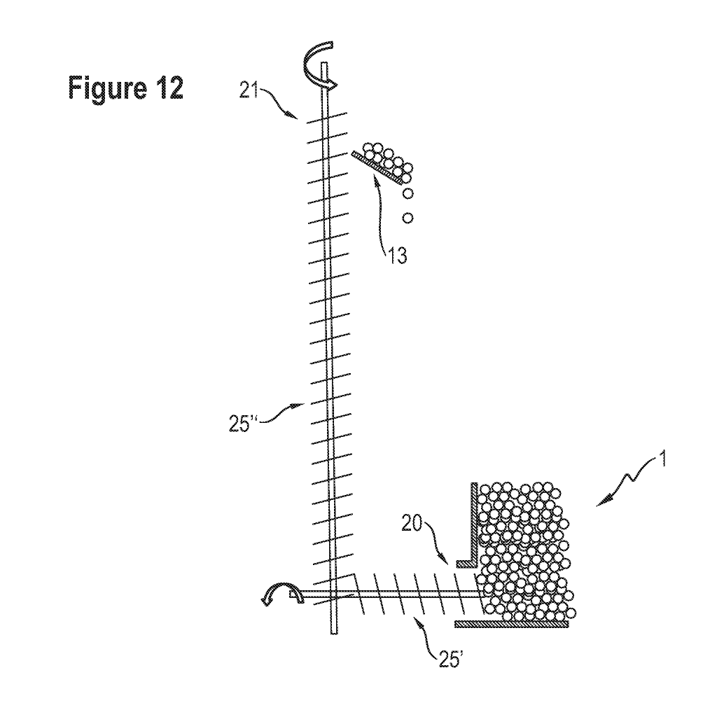

An alternative for the conveyor screw is depicted in FIG. 12, including a horizontally arranged feeding portion 25′ and a vertically arranged lifting portion 25″, wherein the latter basically corresponds to the vertical screw conveyor 25 of the previously described embodiment. The feeding portion 25′ draws in in grinding media and slurry from the bottom section of the grinding chamber. The lifting portion 25″ takes the grinding media and slurry to the elevated level C.

The grinding media handling systems and the grinding media discharge devices according to the present invention represent a retrofit option. Hence, a handling system and/or a discharge device according to the invention can be used for an existing vertical grinding mill. For example, the discharge device can be connected to the door of the grinding chamber, so that it is moved together with the door when the door is opened.

### The Following Items are Also Related to the Invention

Item 1: A grinding media handling system for a vertical grinding mill (1), the handling system comprising:

a reservoir (5),

a pump, such as a sump pump (4) or a horizontal pump (4′), for pumping water and/or a slurry of material to be ground from the reservoir (5) via an inlet in an upper section (A) of the vertical grinding mill into a grinding chamber of the mill,

means for adding grinding media to the water and/or slurry upstream and/or downstream of the pump, and

means for discharging slurry and grinding media from a lower section (B) of the vertical grinding mill (1).

Item 2: The grinding media handling system of item 1, further comprising a siphon (2) for feeding water or slurry from the grinding chamber against gravity to the upper portion (A) of the mill and back to the reservoir (5).

Item 3: The grinding media handling system of item 2, further including a valve for controlling the siphon (2).

Item 4: The grinding media handling system of item 1, 2 or 3, further comprising a conveyor, such as an auger or a screw conveyor, arranged so as to deliver the grinding media into a water or slurry stream downstream of the pump (4, 4′).

Item 5: The grinding media handling system of item 4, further comprising a pressure feeder such as a peristaltic pump or a vaned impeller, which pressure feeder is arranged at the discharge of the conveyor and fed by the conveyor, and which pressure feeder is configured for feeding the grinding media into the stream of water or slurry while preventing any flowback through the conveyor.

Item 6: The grinding media handling system of any one of the preceding items, further comprising an outlet (16) for the grinding media in a bottom section of the grinding chamber, preferably an opening through a door providing access to the grinding chamber.

Item 7: The grinding media handling system of any of the preceding items, wherein the discharge means are operable independently from the pump (4, 4′).

Item 8: A grinding media discharge device for discharging grinding media from a lower section (B) of a vertical grinding mill (1), wherein the vertical grinding mill (1) may include a grinding media handling system according to any one of the preceding items, wherein the discharge means comprises a screw conveyor (25) configured for conveying grinding media and slurry from a bottom section of a grinding chamber (10) of the vertical grinding mill (1).

Item 9: The grinding media discharge device of item 8, wherein the screw conveyor (25) includes a feeding portion (25′), which preferably extends substantially in a horizontal direction, for drawing in grinding media and slurry from the bottom section of the grinding chamber, and/or a lifting portion (25″) for taking the grinding media and slurry to an elevated level (C).

Item 10: The grinding media discharge device of any of the preceding items 8 and 9, wherein the discharge means further comprises a discharge chute (13) for receiving the slurry and grinding media from the screw conveyor (25) and for discharging the slurry and grinding media.

Item 11: The grinding media discharge device of item 10, wherein the discharge chute further comprises a washing means for washing the slurry and the used grinding media taken out from the vertical grinding mill, wherein the washing means preferably comprises a water supply (15) and/or nozzles for cleaning of the slurry and the used grinding media.

Item 12: The grinding media discharge device of item 10 or 11, wherein the discharge chute comprises screening means (14) for separating the used grinding media, in particular from the slurry and/or from used grinding media having a smaller diameter.

Item 13: The grinding media discharge device of any of the preceding items, further comprising at least one sensor for determining the pressure and/or the level of grinding media inside the grinding chamber (10), wherein the at least one sensor is preferably provided in an area of an outlet (16) for the grinding media and slurry formed in the bottom section of the grinding chamber.

Item 14: A vertical grinding mill comprising a grinding media handling system of any one of items 1 to 7 and/or a grinding media discharge device of any one of items 8 to 13.

Item 15: A method for handling grinding media in a vertical grinding mill, wherein the following steps are performed in this order:
a) fill the vertical mill with a slurry of material to be ground and start an auger of the vertical mill;
b) start a pump (4, 4′) configured for transporting water and/or slurry from a reservoir (5) via an inlet in an upper portion (A) of the vertical grinding mill into a grinding chamber (10) of the mill,
c) start adding grinding media, upstream and/or downstream of the pump, to a stream of water and/or slurry being pumped, and
d) continue operating the pump (4, 4′) to transport the grinding media into the grinding chamber (10).

Item 16: The method for handling grinding media according to item 15, further comprising, after step b) and prior to step d), step c) to start a siphon (2) to feed slurry from the grinding chamber against gravity to the upper portion (A) of the mill and back to the reservoir (5) so as to fill the reservoir (5), wherein step c) may comprise opening a valve of the siphon.

Item 17: The method for handling grinding media according to item 16, further comprising, after step e), step f2) of stopping the siphon (2), preferably by allowing air into a top portion of the siphon (2).

Item 18: The method for handling grinding media according to item 15, 16 or 17, wherein step e) includes monitoring the amount of grinding media in the grinding chamber.

Item 19: The method for handling grinding media according to item 18, further comprising, after step e), step f1) of stopping adding fresh grinding media when the amount of grinding media in the grinding chamber has reached a predetermined level.

We claim:

1. A grinding media handling system for a vertical grinding mill, the handling system comprising:
a reservoir,
a pump, such as a sump pump or a horizontal pump, for pumping water and/or a slurry of material to be ground from the reservoir via an inlet in an upper section of the vertical grinding mill into a grinding chamber of the mill,
means for adding grinding media to the water and/or slurry upstream and/or downstream of the pump, and
means for discharging slurry and grinding media from a lower section of the vertical grinding mill.

2. The grinding media handling system of claim 1, further comprising a siphon for feeding water or slurry from the grinding chamber against gravity to the upper portion of the mill and back to the reservoir.

3. The grinding media handling system of claim 2, further including a valve for controlling the siphon.

4. The grinding media handling system of claim 1, further comprising a conveyor, such as an auger or a screw conveyor, arranged so as to deliver the grinding media into a water or slurry stream downstream of the pump.

5. The grinding media handling system of claim 4, further comprising a pressure feeder such as a peristaltic pump or a vaned impeller, which pressure feeder is arranged at the discharge of the conveyor and fed by the conveyor, and which pressure feeder is configured for feeding the grinding media into the stream of water or slurry while preventing any flowback through the conveyor.

6. The grinding media handling system of claim 1, further comprising an outlet for the grinding media in a bottom section of the grinding chamber, preferably an opening through a door providing access to the grinding chamber.

7. The grinding media handling system of claim 1, wherein the discharge means are operable independently from the pump.

8. A grinding media discharge device for discharging grinding media from a lower section of a vertical grinding mill, wherein the vertical grinding mill includes a grinding media handling system according to claim 1, wherein the discharge means comprises a screw conveyor configured for conveying grinding media and slurry from a bottom section of a grinding chamber of the vertical grinding mill.

9. The grinding media discharge device of claim 8, wherein the screw conveyor includes a feeding portion, which preferably extends substantially in a horizontal direction, for drawing in grinding media and slurry from the bottom section of the grinding chamber, and/or a lifting portion for taking the grinding media and slurry to an elevated level.

10. The grinding media discharge device of claim 8, wherein the discharge means further comprises a discharge chute for receiving the slurry and grinding media from the screw conveyor and for discharging the slurry and grinding media.

11. The grinding media discharge device of claim 10, wherein the discharge chute further comprises a washing means for washing the slurry and the used grinding media taken out from the vertical grinding mill, wherein the washing means preferably comprises a water supply and/or nozzles for cleaning of the slurry and the used grinding media.

12. The grinding media discharge device of claim 10, wherein the discharge chute comprises screening means for separating the used grinding media, in particular from the slurry and/or from used grinding media having a smaller diameter.

13. The grinding media discharge device of claim 8, further comprising at least one sensor for determining the pressure and/or the level of grinding media inside the grinding chamber, wherein the at least one sensor is preferably provided in an area of an outlet for the grinding media and slurry formed in the bottom section of the grinding chamber.

14. A vertical grinding mill comprising the grinding media handling system of claim 1 and the grinding media discharge device of claim 8.

15. A method for handling grinding media in a vertical grinding mill, wherein the following steps are performed in this order:
a) fill the vertical grinding mill with a slurry of material to be ground and start an auger of the vertical mill;
b) start a pump configured for transporting water and/or slurry from a reservoir via an inlet in an upper portion of the vertical grinding mill into a grinding chamber of the mill;
d) start adding grinding media, upstream and/or downstream of the pump, to a stream of water and/or slurry being pumped; and
e) continue operating the pump to transport the grinding media into the grinding chamber.

16. The method for handling grinding media according to claim 15, further comprising, after step b) and prior to step d), step c) to start a siphon to feed slurry from the grinding chamber against gravity to the upper portion of the mill and back to the reservoir so as to fill the reservoir, wherein step c) may comprise opening a valve of the siphon.

17. The method for handling grinding media according to claim 16, further comprising, after step e), step f2) of stopping the siphon, preferably by allowing air into a top portion of the siphon.

18. The method for handling grinding media according to claim 15, wherein step e) includes monitoring the amount of grinding media in the grinding chamber.

19. The method for handling grinding media according to claim 18, further comprising, after step e), step f1) of stopping adding fresh grinding media when the amount of grinding media in the grinding chamber has reached a predetermined level.
